(19) United States
(12) Patent Application Publication
(10) Pub. No.: US 2007/0201425 A1
(43) Pub. Date: Aug. 30, 2007

(54) Method Of Selecting Operational Parameters In A Communication Network

(75) Inventors: Kevin I. Smith, Exeter (GB); Richard M. Everson, Exeter (GB); Jonathan E. Fieldsend, Swindon (GB); Misra Rashmi, Gloucestershire (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 10/598,266

(22) PCT Filed: Mar. 4, 2005
(86) PCT No.: PCT/US05/06886

§ 371 Date: Aug. 23, 2006

(30) Foreign Application Priority Data
Mar. 18, 2004 (GB) 0406083.6

(51) Int. Cl. H04L 12/28

(52) U.S. Cl. 370/351

(57) ABSTRACT

The present invention provides a method of selecting operational parameters of a communication network. The method is characterised by searching the operational parameter space using a multiple objective simulated annealing (MOSA) process, wherein the objectives are based upon performance indicators (PIs) of the communication network. Moreover, the MOSA process generates an archive of estimated values of a Pareto front, and employs a dominance-based energy function. The present invention thus provides the benefit of enabling assessment of different estimated optimal trade-offs between multiple objectives.

### TECHNICAL FIELD

The invention relates to a method of selecting operational parameters in a communication network. In particular, it relates to a method of selecting operational parameters in a communication network, the method utilising a simulated annealing process.

### BACKGROUND

Communication networks, for example mobile communication networks, require optimisation procedures that help to balance competing performance indicators such as coverage, capacity and quality of service. Typically these optimisations must be performed as a function of network parameters such as, in the case of mobile communication networks, frequency allocation, pilot power and antenna orientation (e.g. azimuth and downtilt).

Traditional optimisation algorithms typically build a system model and then search the parameter space to identify an optimal value of a performance metric function related to an objective, such as a performance indicator. Search methods for exploring large parameter spaces include genetic algorithms and simulated annealing processes:

Genetic algorithms (GAs) analogise evolution under an environmental constraint. GAs splice possible parameter representations together and assess the fitness of the resulting metric against an objective. The parameters for the more favourable results are kept from a range of splicings and the process is then iterated, optionally with additional random permutations. However, there is no guarantee of convergence on a globally optimal result and relatively little is known about such algorithms' behaviour.

Simulated annealing (SA) processes analogise the crystallisation of a fluid into a minimum-energy state. In SAs, the parameter values are perturbed in relation to a notional temperature. If the resultant change in energy (the chosen metric) is negative, the perturbation is kept. If the resulting change in energy is positive, the perturbation is kept according to a temperature-dependent probability. Thus at high temperatures the system is able to climb out of local energy minima and explore the parameter space. As the ‘temperature’ is slowly reduced, the search of the parameter space becomes increasingly localised and conservative, ideally centring on the global minimum. SAs have the benefit that for sufficiently slow reductions in temperature, a global minimum is guaranteed as shown in S. Geman and D. Geman, “Stochastic relaxation, Gibbs distributions, and the Bayesian restoration of images,” IEEE Trans. Pattern Analysis and Machine Intelligence, vol. 6, pp. 721-741, 1984.

In order to determine an optimum balance between several objectives such as coverage, capacity and quality of service, a single, compound objective metric function must be derived for use in both the optimisation processes described above.

However, the construction of a single metric function incorporates inherent trade-offs and assumptions within it that it would be preferable to consider explicitly:

It may not be sensible to strive for a single optimum trade-off between key objectives, because the relative importance of these objectives may vary with circumstance. For example, variations in cell density over a network may alter the best trade-off between coverage and soft hand-over frequency.

Thus a need exists for a method of selecting operational parameters in a communication network that allows the various trade-offs between objectives to be considered explicitly.

The purpose of the present invention is to address the above problem.

### SUMMARY OF THE INVENTION

The present invention provides a method of selecting operational parameters of a communication network. The method is characterised by searching the operational parameter space using a multiple objective simulated annealing (MOSA) process, wherein the objectives are based upon performance indicators (PIs) of the communication network. Moreover, the MOSA process generates an archive of estimated values of a Pareto front and employs a dominance-based energy function.

The present invention provides the benefit of enabling assessment of different estimated optimal trade-offs between multiple objectives.

In a first aspect, the present invention provides a method of selecting operational parameters of a communication network, as claimed in claim 1.

Further features of the present invention are as defined in the dependent claims.

Embodiments of the present invention will now be described by way of example with reference to the accompanying drawings, in which:

### BRIEF DESCRIPTION OF THE DRAWINGS

FIG. 1 illustrates an energy evaluation of two solutions with respect to a Pareto front, in accordance with an embodiment of the present invention.

FIG. 2 illustrates an attainment surface derived from archived estimates of a Pareto front, in accordance with an embodiment of the present invention.

FIG. 3 similarly illustrates an attainment surface derived from archived estimates of a Pareto front, in accordance with an embodiment of the present invention.

### DETAILED DESCRIPTION

A method of selecting operational parameters of a communication network is disclosed. In the following description, a number of specific details are presented in order to provide a thorough understanding of the present invention. It will be obvious, however, to a person skilled in the art when these specific details need not be employed to practice the present invention. In other instances, well known methods, procedures and components have not been described in detail in order to avoid unnecessarily obscuring the present invention.

Simulated annealing is a popular method of solving single objective optimisation problems where only one dependent variable of the system is under consideration.

However in the field of communications it is clear that a number of variables may need to be optimised in the setting up or running of a communication system.

Whilst some genetic algorithms exist for multiple objective problems (e.g. see C. A. C Coello, “A Comprehensive Survey of Evolutionary-Based Multiobjective Optimization Techniques,” Knowledge and Information Systems. An International Journal, vol. 1, no. 3, pp. 269-308, 1999), methods for simulated annealing typically rely on combining multiple objectives into a single objective function.

For example, see P. Engrand, “A multi-objective approach based on simulated annealing and its application to nuclear fuel management,” in 5th International Conference on Nuclear Engineering, Nice, France, 1997, pp. 416-423, P. Czyzak and A. Jaszkiewicz, “Pareto simulated annealing—a metaheuristic technique for multiple-objective combinatorial optimization,” Journal of Multi-Criteria Decision Analysis, vol. 7, pp. 34-47, 1998, or A. Suppapitnarm, K. A. Seffen, G. T. Parks, and P. J. Clarkson, “A simulated annealing algorithm for multiobjective optimization,” Engineering Optimization, vol. 33, pp. 59-85, 2000.

However, these methods suffer from the problems of inherent trade-offs and assumptions noted previously, and have problems in converging and/or in properly exploring the possible parameter space.

The present invention provides an alternative multiple-objective simulated annealing (MOSA) process, using a dominance based energy function rather than a combined single objective function. To explain the proposed process, dominance and multiple objective simulated annealing are now discussed in more detail:

A. Dominance and Pareto Optimality

In a multi-objective optimisation one attempts to simultaneously maximise or minimise D objectives, yᵢ; which are functions of P variable parameters or decision variables, x=(x₁, x₂, . . . , x_{P})
yᵢ=f(x); i=1, . . . , D (1)

Without loss of generality, assume that the objectives are to be minimised. The multi-objective optimisation problem may then be expressed as:
Minimise y=f(x)≡(f₁(x), . . . , f_{D}(x)) (2)

The notion of dominance is generally used to compare two solutions a and b: If f(a) is no worse for all objectives than f(b) and wholly better for at least one objective, it is said that a dominates b, denoted a [symbol] b. Thus a [symbol] b if:
fᵢ(a)≦fᵢ(b) ∀i=1, . . . , D and
fᵢ(a)<fᵢ(b) for at least one i. (3)

Clearly the dominates relation is not a total order and two

solutions are mutually non-dominating if neither dominates

the other. A set F of solutions is said to be a non-dominating set if no element of the set dominates any other:
a/ [symbol] b∀a,bεF (4)

A solution is said to be globally non-dominated, or Pareto optimal, if no other feasible solution dominates it. The set of all Pareto-optimal solutions is known as the Pareto-optimal front or Pareto set, P.

Solutions in the Pareto set thus represent the possible optimal trade-offs between competing objectives.

In the context of a communication system where the objectives are related to performance indicators, and the solutions are based upon values of network parameters, this clearly provides a mapping between parameter values and a plurality of trade-off positions that may be selected.

The selection process may then be conducted either by considering the importance of the different objectives in a given situation.

It should be noted that in practice, the non-dominated set produced by one or more runs of such a MOSA would in all likelihood only be an estimate of the true Pareto front. Consequently the set produced by such a process is referred to hereinafter as the archive of the estimated Pareto front, denoted F.

B. Simulated Annealing

As noted previously, simulated annealing is the computational analogue of slowly cooling a metal so that it adopts a low-energy, crystalline state. In such an analogy, at high temperatures particles are free to move fluidly, but as the temperature is lowered they are increasingly confined due to the high energy cost of movement.

It is physically appealing to call the function to be minimised the energy, E(x), of the solution (state) x and to introduce a parameter T, the computational temperature which is lowered throughout the simulation according to an annealing schedule. At each T the SA process aims to draw samples from the equilibrium distribution π_{T}(x)∝exp{−E(x)/T}. As T→0 the probability mass of π_{T} is increasingly concentrated in the region of the global minimum of E, so that any sample from π_{T} will most probably lie at the minimum of E.

Sampling from the equilibrium distribution is usually achieved by Metropolis-Hastings sampling, which involves making proposals x′ that are accepted with probability
A=min(1,exp{−δE(x′,x)/T}) (5)
where
δE(x′,x)=E(x′)−E(x) (6)

Thus, when the notional temperature T is high, perturbations from solution x to proposed solution x′ that increase the energy, i.e. δE(x′,x)>0, are likely to be accepted. Note that peturbations from x to x′ that decrease the energy are always accepted by the formulation of equation (5).

Thus when the temperature is high, samples from the equilibrium distribution can easily explore the state space as the ability to accept higher-energy solutions enables escape from local minima.

As T decreases however, only perturbations leading to smaller increases in E are accepted.

Consequently, only a limited exploration of the state space becomes possible as the system settles, ideally, on the global minimum.

The SA process described is summarised in Table 1 below. During K epochs, the computational temperature is fixed at Tₖ, and Lₖ samples are drawn from π_{T}_{ₖ} before the temperature is lowered in the next epoch. Candidate solutions, x′, are drawn from a proposal density (line 3). A candidate solution x is then accepted with a probability as given by equation (5), as shown in lines 4-8.

Preferably, one obtains candidates x′ by perturbing each element of x singly, drawing an additative perturbations from a Laplacian distribution p(ε)∝e^{-|σε|} that has tails which decay relatively slowly, thus ensuring that there is a high probability of exploring regions distant from the current solutions. However it will be clear to a person skilled in the art that alternative perturbation functions may be used.

TABLE 1
Simulated Annealing Process

| Inputs: | |
|---|---|
| {L_{K}}ₖ₌₁^{K} | Sequence of epoch durations |
| {T_{K}}ₖ₌₁^{K} | Sequence temperatures, Tₖ₊₁ < Tₖ |
| x | Initial feasible solution |

| Steps: | |
|---|---|
| 1: for k := 1,...,K | |
| 2: | for i := 1,...,Lₖ |

| | |
|---|---|
| 3: | x′ := perturb( ) |
| 4: | δE := E(x′) − E(x) |
| 5: | u := rand(0, 1) |
| 6: | if u < min(1, exp(−dE/Tₖ)) |

| | |
|---|---|
| 7: | x := x′ |

| | |
|---|---|
| 8: | end |

| | |
|---|---|
| 9: | end |
| 10:end | |

C. Multi-Objective Simulated Annealing

As noted previously, traditional attempts to incorporate multiple objectives within a simulated annealing process have concentrated on combining the objectives into a weighted sum:

$$E ( x ) = {\sum }_{i = 1}^{D} {w}_{i} {f}_{i} ( x ) \qquad ( 7 )$$

The composite objective is then used as the energy to be minimised. Such an approach results in convergence to points on the Pareto front where the objectives have ratios given by wᵢ⁻¹ (where such points exist), and so the inherent trade-offs and assumptions built into the selection of the weights wᵢ are expressed in the limited way that the parameter space is searched.

Consequently, the inventors of the present invention propose an alternative energy function, based not on a composite objective, but on dominance between objectives:

In single objective optimisation problems the energy E(x) is an absolute measure of the quality of any solution x and the optimum is that solution x with the lowest energy. However, in the multi-objective case optimum solutions are only meaningfully defined in relation to each other: the Pareto front is the set of solutions that dominate all other solutions.

The inventors have appreciated that one can compare the relative quality of x and x′ with the dominance relation, but note that it gives essentially only three values of quality—better, worse, or equal—in contrast to the energy difference in uni-objective problems which usually gives a continuum.

However, the inventors have further appreciated that if the true Pareto front P were available, one could define an energy of x as the measure of the front that dominates x:

Let Pₓ be the portion of P that dominates x
Pₓ={yεP|yx} (8)
Then define
E(x)=μ(Pₓ) (9)
where μ is a measure defined on P. For simplicity but without loss of generality, one may take μ(Pₓ) to be the cardinality of Pₓ when Pₓ is finite. If P is a continuous set, we can take μ to be the Lebesgue measure (informally, the length, area or volume for 2, 3 or 4 objectives).

As illustrated in FIG. 1, this energy E(x) has the desired properties: if xεP then E(x)=0, and solutions more distant from the Pareto front 100 are in general dominated by a greater proportion of P and so have a higher energy; in FIG. 1 the solution 101 marked by an open circle has a greater energy than the solution 102 one marked by a filled circle.

Clearly, this formulation of energy E(x) does not rely on an a priori weighting of the objectives. Consequently the disadvantages of a composite objective energy function are avoided and the guarantee of convergence for uni-objective SA continues to hold.

More significantly, because all solutions lying on the Pareto front have equal minimum energy, one may expect that a simulated annealer using the dominance energy measure will, on reaching the Pareto front, perform a random walk exploration of it. This enables a thorough exploration of the optimal trade-offs possible between the objectives.

As noted previously, in practice the true Pareto front P is unavailable, and so in an embodiment of the present invention, an archive of estimated values of the Pareto front, F, is used instead.

Noting that F is the set of mutually non-dominating solutions found thus far during the annealing process, then denote \tilde{F} as the union of F with the current solution x and the proposed perturbation to that solution x′.

In a similar fashion to equation (8), let \tilde{F}ₓ be the elements of \tilde{F} that dominate x:
\tilde{F}ₓ={yε\tilde{F}|yx} (10)
so that an energy difference between the current and proposed solutions is obtained as

$$δ E ( x , {x}^{′} ) = \frac{1}{\vert \tilde{F} \vert} ( \vert {\tilde{F}}_{x} \vert - \vert {\tilde{F}}_{{x}^{′}} \vert ) \qquad ( 11 )$$

Where division by |\tilde{F}| ensures that εE<1, and mutes the impact of changes to the number of solutions in the set F on the value of δE.

The inclusion of the current solution x and proposed perturbation to the solution x′ in \tilde{F} ensures that εE(x,x′)<0 if x′ [symbol] x. This ensures that proposed solutions that move the estimated Pareto front towards the true Pareto front are always accepted.

As noted previously, this new dominance-based energy measure provides a single energy function that encourages convergence towards and subsequent coverage of the Pareto front of a multi-objective system, without any modification to the simulated annealing process other than the archival of Pareto-front estimates F.

However, when the archive set F is initially small, the energy resolution of εE is correspondingly coarse and may impact upon the operation of the acceptance criterion described in equation (5). A low resolution of probability additionally discriminates against higher energy perturbations at low temperatures and is preferably avoided.

Consequently, in an enhanced embodiment of the present invention, the population of set F is boosted by interpolated values.

Preferably, the interpolated points satisfy three criteria:
i. The interpolated points must be sufficiently close to the current estimation of the Pareto front that they can affect the energy of new solutions generated near the current estimated Pareto front;
ii. The interpolated points must be evenly distributed across the currently estimated Pareto front so as to not bias the MOSA process away from poorly populated regions of the front.
iii. The interpolated points must not dominate any proposal that is not dominated by any member of F, so that solutions that may potentially join F are not incorrectly discarded. Consequently an interpolated point must be dominated by at least one current member of F.

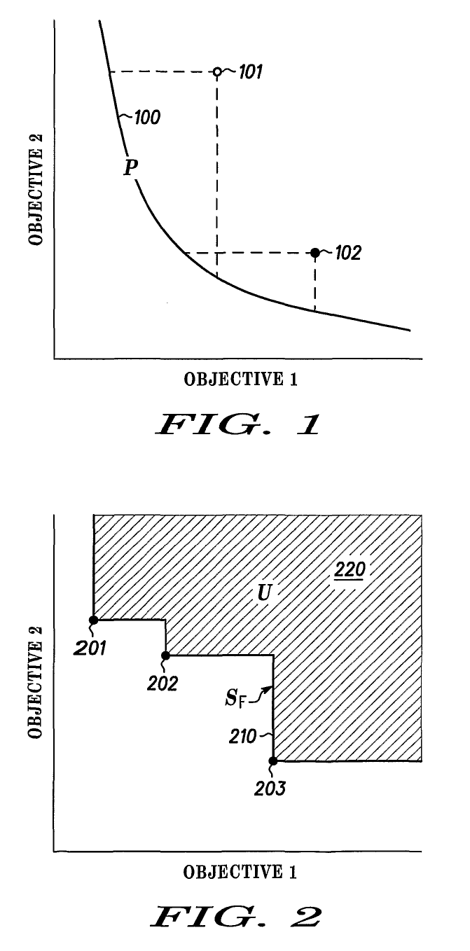

Such an interpolation surface exists in the form of an attainment surface S_{F}. As can be seen in FIG. 2, this attainment surface is a conservative interpolation describing the boundary of the region in objective space U 220 that is dominated by at least one element of F. In FIG. 2, this boundary 210 is drawn for a set F comprising three two-dimensional elements 201, 202 and 203.

Formally, if U, Vε [symbol] ^{D} then u properly dominates v (denoted u [symbol] v) if uᵢ<vᵢ ∀i=1, . . . , D. Then if
F={y|uy for some uεF} (12)
and U={y|uy for some uεF} (13)
the attainment surface S_{F}=F/U.

The attainment surface may be sampled as summarised in Table 2 below, in which a point is sampled from a uniform distribution on the axis-parallel hyper-rectangle bounding F and then one coordinate is restricted so that the point is dominated by an element of F.

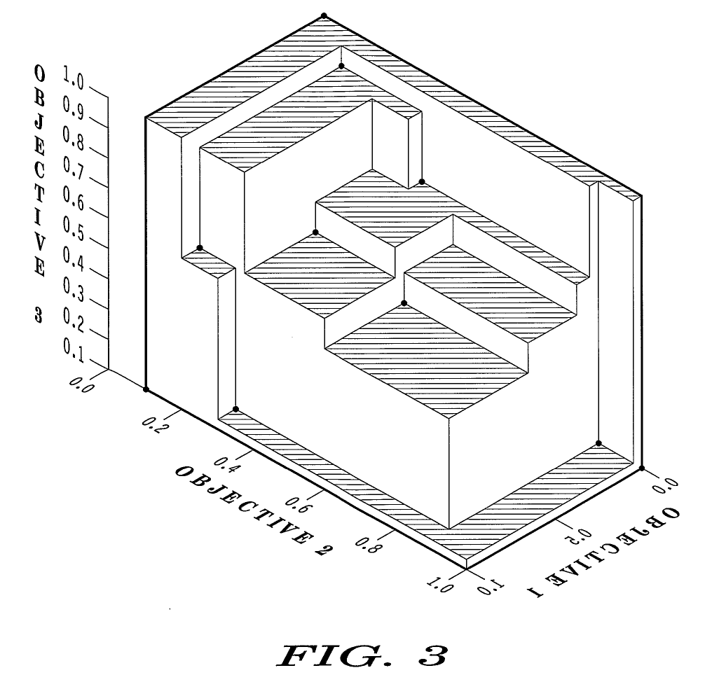

Determining whether an element of F dominates v on line 8 of the process listed in Table 2 may be efficiently implemented using a binary searches of the lists Lᵢ, in which case the problem is of order O(|F|log(|F|)) for the generation of each sample. FIG. 3 illustrates the resulting sampled attainment surface for a set F comprising ten 3-dimensional points, with 10,000 samples shown for visualisation purposes only.

TABLE 2
Sampling a point from the attainment surface

| Inputs: | |
|---|---|
| {Lᵢ}ᵢ₌₁^{D} | Elements of F, sorted by increasing coordinate |

| Generate a random point, v: | |
|---|---|
| 1: for i := 1, ... ,D | |
| 2: | vᵢ := rand(min(Lᵢ), max(Lᵢ)) |
| 3: end | |

| 4: d := randint(1,D) | |
|---|---|
| Find smallest v_{d} such that v is dominated by a y ε F: | |
| 5: for i = 1, ... ,\|F\| | |
| 6: | u = L_{d,i} |
| 7: | v_{d} := u_{d} |
| 8: | if F [symbol] v |

| | |
|---|---|
| 9: | return v |

| | |
|---|---|
| 10: | end |
| 11: end | |

D. Process Control

In common with other SA processes, the performance of the MOSA process described herein is influenced by the selection of the initial temperature, annealing schedule and perturbation size. Options for these aspects of the MOSA process are presented below.

If the initial temperature of the system is set too high, all proposed solutions will be accepted, irrespective of their relative energies, whereas if it is set too low then proposals with a higher energy than the current solution will not be accepted, turning the process into a greedy search.

Thus a reasonable initial temperature to set achieves an initial acceptance rate of approximately 50% on derogatory (increased energy) proposals. This initial temperature, T₀; can be easily calculated by using a short ‘burn-in’ period during which time all solutions are accepted, and then setting the temperature equal to the average positive change of energy divided by ln(2). It will be clear to a person skilled in the art that alternative strategies for estimating an initial temperature exist, such as initially increasing T₀ until an roughly 50% of accepted proposals are derogatory.

A reasonable annealing schedule adjusts the temperate according to Tₖ=β^{k}T₀, for the k^{th} epoch, where β is less than 1.

It will be clear to a person skilled in the art that alternative initial temperatures and annealing schedules may be employed.

In the context of the present invention, perturbation size may advantageously be distinguished for those solutions approaching the estimated Pareto front (location perturbations), versus those solutions actually traversing the estimated Pareto front (transversal perturbations).

In an embodiment of the present invention, the parameter to be perturbed is chosen at random, and as noted previously is perturbed with a random variable drawn from a laplacian distribution p(ε)∝e^{-|σε|}, where the scaling factor σ alters the magnitude of permutation. By maintaining two sets of scaling factors, two perturbation sizes may be distinguished.

A scaling factor is maintained for each dimension of parameter space for each of location perturbations and traversal perturbations, and these are adjusted independently. When perturbing a solution, it may be chosen

randomly with equal probability whether the location scaling set or the traversal scaling set will be used. This reduces the possibility of traversing within a local minima if the estimated Pareto front has not yet converged near the true Pareto front.

The scalings may be initially set large enough to sample from the entire feasible space. The scalings are then adjusted throughout the optimisation, whenever a suitably large statistic set is available to reliably calculate an appropriate scaling factor.

In an embodiment of the present invention, traversal scaling is recalculated for a particular decision variable, xⱼ, whenever approximately 50 traversal perturbations have been made to xⱼ since the last resealing. In order to ensure wide coverage of the estimated front, it is desirable to maximise the distance (in objective space) covered by the traversals to ensure the entire front is evenly covered.

Proposals are preferably generated on approximately the scale that has previously been successful in generating wide-ranging traversals. To achieve this, the perturbations are sorted by absolute size of perturbation in parameter space, and then trisected in order, giving three groups, one of the smallest third of perturbations, the largest third of perturbations, and the remaining perturbations.

For each group the mean traversal size caused by the perturbations is calculated. The traversal size is measured as the Euclidean distance traveled in objective space when the current solution and the proposed solution are mutually non-dominating. The traversal perturbation scaling for decision variable xⱼ is then set to the average perturbation of the group that generated the largest average traversal.

In an embodiment of the present invention, location scaling is adjusted in an attempt to maintain the acceptance rate for proposed perturbations x′ that have a higher energy than x to approximately one third, so that exploratory proposals are made and accepted at all temperatures.

The location perturbation scaling is typically recalculated for each parameter for which 20 proposals with energies greater than the current solution have been generated, after which the count is reset. Location perturbation resealing may be omitted in two cases:
i. when the archive of the estimated Pareto front F has fewer than 10 members; and
ii. when the combined size of F augmented by the samples from the attainment surface when multiplied by the temperature does not exceed 1.

The latter accommodates that in attempting to keep the acceptance rate of derogatory moves to approximately a third, then when this value is too small it becomes impossible to generate such a scaling and so the scalings are kept at the most recent valid value.

Only counting moves generated from perturbations to a particular dimension of parameter space, the acceptance rate of derogatory moves α is the fraction of proposals to a greater energy which are accepted. If σ denotes the location perturbation scaling for a particular dimension, the new σ is set as:

$$σ := \{ \begin{matrix}σ ( 1 + 2 ( α - 0.4 ) / 0.6 ) & if α > 0.4 \\ σ / ( 1 + 2 ( 0.3 - α ) / 0.3 & if α < 0.3\end{matrix} \qquad ( 14 )$$

This update scheme exploits the tendency for smaller perturbations in parameter space to generate small changes in objective space, resulting in smaller changes in energy.
E. Objectives and Trade-Off Selection in Communication Networks

In an embodiment of the present invention, the above process may be used to consider trade-offs between objectives falling within any or all of the following categories;
i. Capacity;
ii. Coverage; and
iii. Quality of service.

Capacity may comprise one or more objectives, such as mean traffic level, or voice and data capacities.

Coverage may comprise one or more objectives, such as the range within a cell, mean traffic power per user, the percentage of users whose devices do not receive a pilot above a given threshold signal strength, or an out-of-cell to in-cell interference ratio.

Quality of service may comprise one or more objectives, such as the average ratio between the mobile Eb/No (energy per bit noise floor) achieved and an Eb/No target, the mean data rate, or average soft handover factors.

It will be clear to a person skilled in the art that other objectives may be considered in different communication networks.

The estimated Pareto front generated by the process described herein will then represent possible estimated optimal trade-offs between the selected objectives. By applying different notional costs to different objectives and/or parameters for a given set of circumstances, the cheapest trade-off may then be selected as the best for those circumstances.

Obtaining different trade-offs for different scenarios then simply requires alteration to the costing.

The operational parameters underlying the best solution may then be applied to the communication network.

Whilst the proposed method is applicable to any communication network in which two or more objectives by traded off each other by the selection of operational network parameters, it is envisaged as being of particular use in the field of mobile communication networks utilising GSM, CDMA, UMTS, GPRS, IP, or general radio access networking technology.

It will be understood that the method of selecting operational parameters of a communication network as described above, provides at least one or more of the following advantages:
i. Estimates are obtained of trade-offs between multiple objectives of a communication network;
ii. Knowledge of the relative weights of the objectives need not be known prior to the MOSA process;
iii. Objectives are not aggregated into a single energy metric for the parameter search, which would bias and/or limit the search process;
iv. Network designers can evaluate a wide set of possible trade-off solutions; and
v. The posited set of trade-offs may be investigated and selected between by costing different scenarios.

1. A method of selecting operational parameters of a communication network, characterised by;
searching an operational parameter space using a multiple objective simulated annealing (MOSA) process wherein;
the objectives are based upon performance indicators of the communication network;
the MOSA process generates an archive of estimated values of a Pareto front; and
the MOSA process employs a dominance-based energy function.

2. A method according to claim 1, wherein the dominance-based energy function, E(x), is defined substantially as
E(x)=μ(\tilde{F}ₓ),
where μ is a measure defined on \tilde{F}ₓ, and \tilde{F}ₓ is defined substantially as
\tilde{F}ₓ={yε\tilde{F}|yx},
such that \tilde{F}ₓ is the set of elements of \tilde{F} that dominate solution x, where \tilde{F} is the union of the current set of mutually non-dominating solutions found, with the current solution x and the proposed perturbed solution x′.

3. A method according to claim 1, wherein the difference in the dominance-based energy function between current solution x and proposed perturbed solution x′ is evaluated substantially as
$$δ E ( x , {x}^{′} ) = \frac{1}{\vert \tilde{F} \vert} ( \vert {\tilde{F}}_{x} \vert - \vert {\tilde{F}}_{{x}^{′}} \vert ) ,$$
all terms as defined herein.

4. A method according to claim 1, wherein additional values of the estimated Pareto front are obtained by randomly sampling an attainment surface of the archive of estimated values of the Pareto front.

5. A method according to claim 1, wherein the MOSA process may propose a perturbation to the present solution x that is scaled using one of two scaling schemes;
i. transversal scaling
ii. location scaling

6. A method according to claim 1, wherein objectives may be based upon performance indicators of the communication network from any or all of the following categories;
i. Capacity;
ii. Coverage; and
iii. Quality of service.

7. A method according to claim 1, wherein cost values are applied the objectives and/or the operational parameters according to a given scenario.

8. A method according to claim 7, wherein the solution with the lowest cost within the archive of estimated values of the Pareto front is chosen for a given scenario.

9. A method according to claim 1, wherein the operational parameter values associated with a chosen solution are incorporated within the communication network.

10. (canceled)
